(19) United States
(12) Patent Application Publication
(10) Pub. No.: US 2026/0156666 A1
(43) Pub. Date: Jun. 4, 2026

(54) CHANNEL STATE INFORMATION (CSI) FEEDBACK REPORTING IN WIRELESS NETWORKS

(71) Applicant: RAKUTEN SYMPHONY, INC., Tokyo (JP)

(72) Inventors: Subramanya CHANDRASHEKAR, Karnataka (IN); Raghavendra Madanahally RAMAKRISHNA, Karnataka (IN)

(73) Assignee: RAKUTEN SYMPHONY, INC., Tokyo (JP)

(21) Appl. No.: 18/706,548

(22) PCT Filed: Mar. 1, 2024
(86) PCT No.: PCT/US2024/017960

§ 371 Date: May 1, 2024

(30) Foreign Application Priority Data
Aug. 2, 2023 (IN) 202341052059
Dec. 15, 2023 (IN) 202341052059

(51) Int. Cl. H04W 72/542; H04W 72/231

(52) U.S. Cl. CPC H04W 72/542; H04W 72/231

(57) ABSTRACT

Embodiments of the present disclosure disclose a Base Station (BS)-Distributed Unit (DU) (102). The BS-DU (102) is configured to transmit a Channel State Information Reference Signal (CSI-RS) and a Physical Resource Block (PRB) group size to a User Equipment (UE) (104), wherein the UE (104) performs CSI prediction of a wireless channel between the UE (104) and the BS-DU (102) using the PRB group size, receive a ground truth CSI-RS periodically from the UE (104), determine values of one or more channel selectivity parameters of the wireless channel, based on the received ground truth CSI-RS from the UE (104), determine an updated PRB group size, based on the values of the one or more channel selectivity parameters, and transmit the updated PRB group size to the UE (104), wherein the UE (104) performs the CSI prediction of the wireless channel using the updated PRB group size.

### CROSS-REFERENCE TO RELATED APPLICATION(S)

This application claims the benefit of Indian Provisional Application No 202341052059, entitled “METHOD AND SYSTEM FOR TRANSMITTING CHANNEL STATE INFORMATION (CSI) FEEDBACK WITH VARYING GRANULARITY” filed on Aug. 2, 2023 and Indian Application No. 202341052059, entitled “CHANNEL STATE INFORMATION (CSI) FEEDBACK REPORTING IN WIRELESS NETWORKS” filed on Dec. 15, 2023, which are expressly incorporated by reference herein in its entirety.

### TECHNICAL FIELD

The present disclosure relates to Channel State Information (CSI) feedback reporting in wireless networks.

### BACKGROUND

In wireless communication networks, for example in 5^{th} Generation New Radio (5G NR), Channel State Information (CSI) describes channel properties of a radio channel or a communication link. For instance, the CSI describes properties of signal propagation such as scattering, fading, power decay, and the like. Channel State Information Reference Signal (CSI-RS) is a reference signal (RS) that is used in Downlink (DL) direction. Herein, the CSI-RS is utilised for the purpose of channel sounding and used to measure characteristics of the radio channel so that the channel utilizes correct modulation, code rate, beam forming, and the like. Generally, a base station (for instance, gNodeB or gNB) associated with the wireless communication network transmits the CSI-RS in a periodic or an aperiodic manner in the DL. A User Equipment (UE) performs CSI prediction in response to the CSI-RS received from the base station. In an example, the UE may measure the CSI such as, a transmission rank, a precoder matrix indicator, a channel quality indicator, and the like.

The UE performs the CSI prediction based on actual received CSI-RS samples in the DL from the base station. Notably, the CSI prediction is not performed for each individual Physical Resource Block (PRB), but instead performed for a group of PRBs (For example, 2 PRBs, 4 PRBs, 8 PRBs, and the like). Herein, a size of the group of PRBs is directly dependent on frequency selectivity of a channel. The size of the group of PRBs to be used for the CSI prediction is provided to the UE over Radio Resource Control (RRC) signalling.

Also, with advancement in communication technologies, there are advanced techniques which use Artificial Intelligence (AI)/Machine Learning (ML) based CSI estimation and prediction. In such techniques, each of multiple UEs in the wireless communication network transmits CSI feedback along with assistance information to the base station, for enhancing the CSI feedback.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure discloses a Base Station (BS)-Distributed Unit (DU). The BS-DU is configured to transmit a Channel State Information Reference Signal (CSI-RS) and a Physical Resource Block (PRB) group size to a User Equipment (UE). The UE performs CSI prediction of a wireless channel between the UE and the BS-DU using the PRB group size. Further, the BS-DU receives a ground truth CSI-RS periodically from the UE. The BS-DU determines values of one or more channel selectivity parameters of the wireless channel, based on the received ground truth CSI-RS from the UE. Furthermore, the BS-DU determines an updated PRB group size, based on changes in the values of the one or more channel selectivity parameters. Thereafter, the BS-DU transmits the updated PRB group size to the UE. The UE performs the CSI prediction of the wireless channel using the updated PRB group size.

In an embodiment, the present disclosure discloses a method. The method comprises transmitting a Channel State Information Reference Signal (CSI-RS) and a Physical Resource Block (PRB) group size to a User Equipment (UE). The UE performs CSI prediction of a wireless channel between the UE and the BS-DU using the PRB group size. Further, the method comprises receiving a ground truth CSI-RS periodically from the UE. The method comprises determining values of one or more channel selectivity parameters of the wireless channel, based on the received ground truth CSI-RS from the UE. Furthermore, the method comprises determining an updated PRB group size, based on changes in the values of the one or more channel selectivity parameters. Thereafter, the method comprises transmitting the updated PRB group size to the UE. The UE performs the CSI prediction of the wireless channel using the updated PRB group size.

In an embodiment, the present disclosure discloses a non-transitory computer readable medium. The non-transitory computer readable medium includes instructions for performing operations comprising transmitting a Channel State Information Reference Signal (CSI-RS) and a Physical Resource Block (PRB) group size to a User Equipment (UE). The UE performs CSI prediction of a wireless channel between the UE and the BS-DU taking into account the configured PRB group size. Further, the operation comprises receiving a ground truth CSI-RS periodically from the UE. The operation comprises determining values of one or more channel selectivity parameters of the wireless channel, based on the received ground truth CSI-RS from the UE. Furthermore, the operation comprises determining an updated optimal PRB group size, based on the changed values of the one or more channel selectivity parameters. Thereafter, the operation comprises transmitting the updated PRB group size to the UE. The UE performs the CSI prediction of the wireless channel using the updated PRB group size.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary environment for reporting Channel State Information (CSI) in wireless networks, in accordance with some embodiments of the present disclosure;

FIG. 2 illustrates a detailed diagram of a Base Station (BS)-Distributed Unit (DU) in wireless networks, in accordance with some embodiments of the present disclosure;

FIG. 3 shows an exemplary flow diagram for reporting CSI in wireless networks, in accordance with some embodiments of the present disclosure;

FIG. 4 shows an exemplary flow chart illustrating method steps for reporting CSI in wireless networks, in accordance with some embodiments of the present disclosure; and

FIG. 5 shows a block diagram of a general-purpose computing system for reporting CSI in wireless networks, in accordance with embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Channel State Information (CSI) describes channel properties of a radio channel or a communication link in wireless communication networks. For instance, the CSI describes properties of signal propagation such as scattering, fading, power decay, and the like. Channel State Information Reference Signal (CSI-RS) is a reference signal (RS) that is used in Downlink (DL) direction. Herein, the CSI-RS is utilised for the purpose of channel sounding and used to measure characteristics of the radio channel so that the channel utilizes correct modulation, code rate, beam forming, and the like. Generally, a base station (for instance, gNodeB or gNB) associated with the wireless communication network transmits the CSI-RS in a periodic or an aperiodic manner in the DL. A User Equipment (UE) performs CSI prediction in response to the CSI-RS received from the base station. In an example, the UE may measure the CSI such as, a transmission rank, a precoder matrix indicator, a channel quality indicator, and the like.

The UE performs the CSI prediction based on actual received CSI-RS samples in the DL from the base station. Notably, the CSI prediction is not performed for each individual Physical Resource Block (PRB), but instead performed for a group of PRBs. The size of the PRBs may vary. For example, the CSI prediction may be performed for 2 PRBs, 4 PRBs, 8 PRBs, and the like. Herein, the size of the group of PRBs is directly dependent on selectivity of the radio channel. For instance, a high frequency selectivity implies a small PRB group size, and a low frequency selectivity implies a high PRB group size.

The size of the PRBs to be used for the CSI prediction is provided to the UE over Radio Resource Control (RRC) signalling. In conventional systems, there is no procedure defined to dynamically update or optimize the size of the PRBs based on the selectivity of the radio channel once the size of the PRBs is provided initially to the UE. The size of the PRBs has an effect on performance of the CSI prediction at the UE. Hence, it is required to update or optimize the size of the PRBs based on the selectivity of the radio channel.

Also, with advancement in communication technologies, there are advanced techniques which use Artificial Intelligence (AI)/Machine Learning (ML) based CSI estimation and prediction. In such techniques, each of multiple UEs in the wireless communication network transmits CSI feedback along with assistance information to the base station, for enhancing the CSI feedback. However, this amounts to huge uplink overhead, as a large number of UEs communicate the enhanced CSI feedback to the base station in the wireless communication network.

The present disclosure provides a Base Station (BS)-Distributed Unit (DU) and a method to overcome the above limitations. In the present disclosure, the BS-DU receives a ground truth CSI-RS periodically from a User Equipment (UE) after transmitting the CSI-RS and a PRB group size initially. The BS-DU monitors channel selectivity parameters of a wireless channel between the UE and the BS-DU, based on the ground truth CSI-RS. The BS-DU determines whether the PRB group size needs to be updated, based on chancel selectivity parameters of the wireless channel. Accordingly, the BS-DU updates the PRB group size and transmits the updated PRB group size to the UE. The UE performs the CSI prediction using the updated PRB group size. Thus, the present disclosure provides a procedure to dynamically update or optimize the PRB group size, based on the channel selectivity parameters. This ensures increased accuracy in the CSI prediction and reporting at the UE.

Notably, the CSI-RS is predicted at the UE and CSI feedback information is sent to the gNB with varying granularity of the PRBs. The prediction of CSI feedback with varying PRB granularity involves dynamically estimating characteristics of the channel. By using finer granularity during periods of rapid channel variations or high mobility, and coarser granularity when channel conditions are stable or resources are limited, the wireless communication network optimizes resource utilization and adapts its transmission parameters efficiently. This dynamic approach enhances spectral efficiency, reduces interference, and boosts overall network capacity, ensuring reliable and high-quality communication services for users in wireless environments.

In the present disclosure, the UE generates the CSI feedback based on channel parameters of the wireless channel. Accordingly, PRB granularity of reporting the CSI feedback can be reduced based on the channel parameters, and compressed CSI feedback can be transmitted to the BS-DU. This ensures reduced uplink overhead in the wireless communication network, without losing the channel information. Also, CSI feedback channel has very stringent error requirements, and hence reducing the overhead significantly reduces uplink resources for transmission.

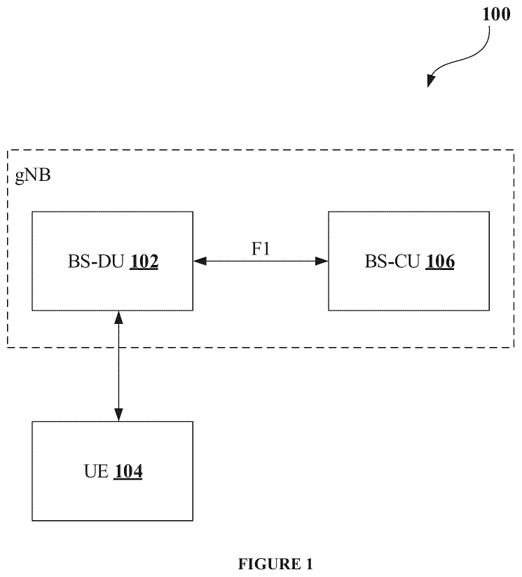

FIG. 1 illustrates an exemplary environment 100 of reporting CSI feedback in wireless networks, in accordance with embodiments of the present disclosure. The exemplary environment 100 comprises a Base Station (BS)-Distributed Unit (DU) 102, a User Equipment (UE) 104, and a Base Station (BS)-Central Unit (DU) 106. The BS-DU 102 and the BS-CU 106 are part of a base station or a gNodeB or a gNB. The description of the present disclosure is explained considering Fifth Generation (5G) networks only. However, the present disclosure is applicable to any type of networks such as Fourth Generation (4G) networks, 5G networks, and the like. In 5G networks, the gNB serves as a 5G base station, responsible for efficient transmission and reception of radio signals to and from UEs. The gNB manages critical functions such as Radio Resource Control (RRC), mobility management, connection control, and the like. A 5G Core (5GC) provides core network functionalities, facilitating scalability and supporting a diverse range of services and applications. Various functional nodes, such as an Access and Mobility Management Function (AMF), Session Management Function (SMF), and User Plane Function (UPF), are part of the 5GC.

In 5G networks, the base station is split into three distinct components i.e., a Centralized Unit (CU) (referred as the BS-CU 106 in the description), a Distributed Unit (DU) (referred as the BS-DU 102 in the description), and a Remote Radio Unit (RU). The BS-CU 106 serves as central intelligence, adeptly handling complex and centralized network functions. These functions include, but not limited to, proficient radio resource management, effective network control, and seamless coordination with the 5GC. The BS-DU 102 is responsible for managing data plane processing, encompassing vital tasks such as data transmission and reception with the User Equipment (UE) 104. The BS-DU 102 interfaces seamlessly with the BS-CU 106 over F1 interface. The RU deals with physical layer functions, housing antennas and radio transceivers that facilitate the actual transmission and reception of radio signals.

The UE 104 represents end-user devices that access services and applications through the wireless network. The UE 104 is configured to connect to the BS-DU 102 over the wireless network. Examples of the UE 104 include, but not limited to, any device used by a user to communicate over the wireless network, such as, but not limited to, mobile phones, smartphones, laptops, wearables, Internet of Things (IoTs), and the like.

The present disclosure relates to reporting CSI feedback in the wireless networks. Channel State Information (CSI) describes channel properties of a radio channel or a communication link. For instance, the CSI describes properties of signal propagation such as scattering, fading, power decay, and the like. Channel State Information Reference Signal (CSI-RS) is a reference signal (RS) that is used in Downlink (DL) direction. Herein, the CSI-RS is utilised for the purpose of channel sounding and used to measure characteristics of the radio channel so that the channel utilizes correct modulation, code rate, beam forming, and the like. Generally, the BS-DU 102 transmits the CSI-RS in a periodic or an aperiodic manner in the DL. The UE 104 performs CSI prediction in response to the CSI-RS received from the BS-DU 102. In an example, the UE 104 may measure the CSI such as, a transmission rank, a precoder matrix indicator, a channel quality indicator, and the like. The UE 104 performs the CSI prediction for a group of Physical Resource Blocks (PRBs) such as 2 PRBs, 4 PRBs, and the like. A PRB is a resource block which is used for actual transmission/reception in the wireless networks.) In an exemplary implementation, the PRB is made up of twelve subcarriers over which the transmissions/receptions are scheduled.

In the present disclosure, the BS-DU 102 is configured to transmit the CSI-RS and a PRB group size to the UE 104. The UE 104 performs CSI prediction of a wireless channel between the UE 104 and the BS-DU 102 for the configured PRB group size. In an example, the PRB group size may be four. In such case, the UE 104 performs the CSI prediction for 2 PRBs. The BS-DU 102 may configure the PRB group size based on channel characteristics, when establishing an initial connection with the UE 104. In the present disclosure, the BS-DU 102 receives a ground truth CSI-RS periodically from the UE 104. The ground truth CSI-RS is received so that the BS-DU 102 can monitor channel characteristics in a periodic manner and determine whether an update in the PRB group size is required based on the channel characteristics.

The BS-DU 102 determines values of one or more channel selectivity parameters of the wireless channel, based on the ground truth CSI-RS received from the UE 104. The one or more channel selectivity parameters may comprise at least one of, a frequency selectivity, a spatial selectivity, and a time selectivity of the wireless channel. In an example, the BS-DU 102 may determine a rate of change of amplitude of a signal transmitted over the wireless channel over time. The BS-DU 102 determines an updated PRB group size, based on changes in the values of the one or more channel selectivity parameters. For example, the BS-DU 102 may determine a higher rate of change of amplitude of the signal over time. The BS-DU 102 may determine that the PRB size needs to be updated. In such case, the updated PRB group size may be determined as four. Then, the BS-DU 102 may transmit the updated PRB group size to the UE 104. In an embodiment, the BS-DU 102 may transmit a request indicating the updated PRB group size to the BS-CU 106. The BS-CU 106 may acknowledge the request and transmit a Radio Resource Control (RRC) reconfiguration message indicating the updated PRB group size to the UE 104. In another embodiment, the BS-DU 102 may transmit the updated PRB group size in a layer 2 medium access control message, to the UE 104. The UE 104 performs the CSI prediction of the wireless channel using the updated PRB group size. Hence, the present disclosure enables dynamic updation of the PRB group size, based on the channel characteristics. Hence, the optimized PRB group size is considered, and accordingly the accuracy of performing the CSI prediction at the UE 104 is improved.

In an embodiment, the BS-DU 102 receives compressed CSI feedback from the UE 104, in response to transmission of the CSI-RS. Herein, the UE 104 generates the compressed CSI feedback, based on the ground truth CSI-RS and one or more channel parameters of the wireless channel. The UE 104 optimizes granularity of reporting the CSI feedback based on the channel parameters. This ensures reduced uplink overhead in the wireless communication network, without losing the channel information.

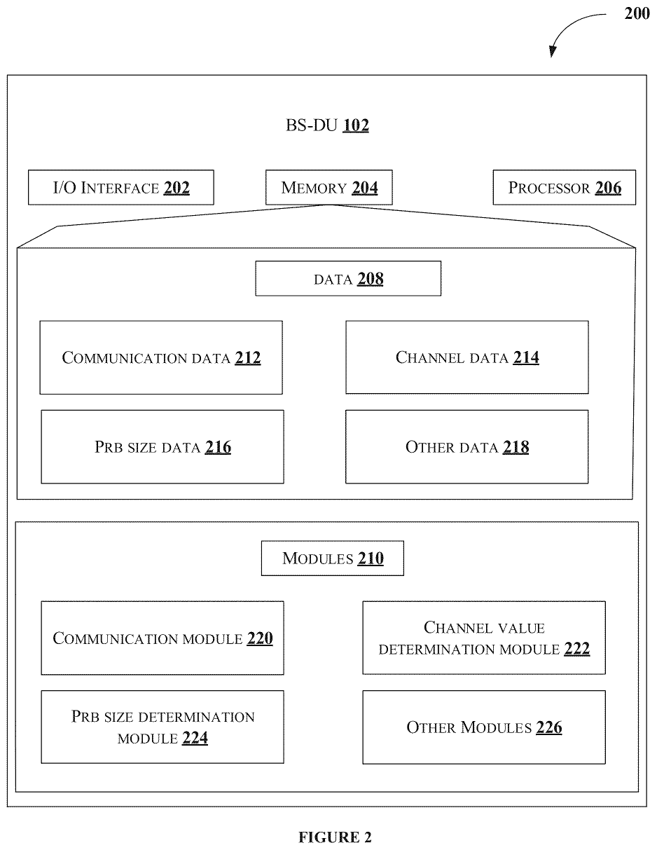

FIG. 2 illustrates a detailed diagram of the BS-DU 102 in the wireless network, in accordance with some embodiments of the present disclosure. The BS-DU 102 may include Input/Output (I/O) interface 202, a memory 204, and a Central Processing Unit (also referred as “CPU” or “a processor 206”). In some embodiments, the memory 204 may be communicatively coupled to the processor 206. The memory 204 stores instructions executable by the processor 206. The processor 206 may comprise at least one data processor for executing program components for executing user or system-generated requests. The memory 204 may be communicatively coupled to the processor 206. The memory 204 stores instructions, executable by the processor 206, which, on execution, may cause the processor 206 to transmit the updated PRB group size for the CSI estimation and reporting the CSI feedback. The I/O interface 202 is coupled with the processor 206 through which an input signal or/and an output signal is communicated. For example, the BS-DU 102 may transmit the updated PRB group size to the UE 104, via the I/O interface 202. In an embodiment, the BS-DU 102 may be implemented in a variety of computing systems, such as a server, a network server, a cloud-based server, and the like.

In an embodiment, the memory 204 may include one or more modules 210 and data 208. The one or more modules 210 may be configured to perform the steps of the present disclosure using the data 208. In an embodiment, each of the one or more modules 210 may be a hardware unit which may be outside the memory 204 and coupled with the BS-DU 102. As used herein, the term modules 210 refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 210 when configured with the described functionality defined in the present disclosure will result in a novel hardware.

In one implementation, the modules 210 may include, for example, a communication module 220, a channel value determination module 222, a PRB size determination module 224, and other modules 226. It will be appreciated that such aforementioned modules may be represented as a single module or a combination of different modules. In one implementation, the data 208 may include, for example, communication data 212, channel data 214, PRB size data 216, and other data 218.

In an embodiment, the communication module 220 may be configured to transmit a CSI-RS and a PRB group size to the UE 104. Herein, the communication module 220 may be configured to transmit the CSI-RS and the PRB group size when the BS-DU 102 establishes a connection with the UE 104 over a wireless channel or a radio channel. The CSI-RS is a reference signal used to perform the CSI prediction. The CSI-RS is utilized for the purpose of channel sounding and used to measure characteristics of the radio channel so that the channel utilizes correct modulation, code rate, beam forming, and the like. The PRB group size refers to a number of PRBs used for performing the CSI prediction. The BS-DU 102 configures the PRB group size based on the channel characteristics of the wireless channel. The channel characteristics affect the PRB group size to be used for the CSI prediction.

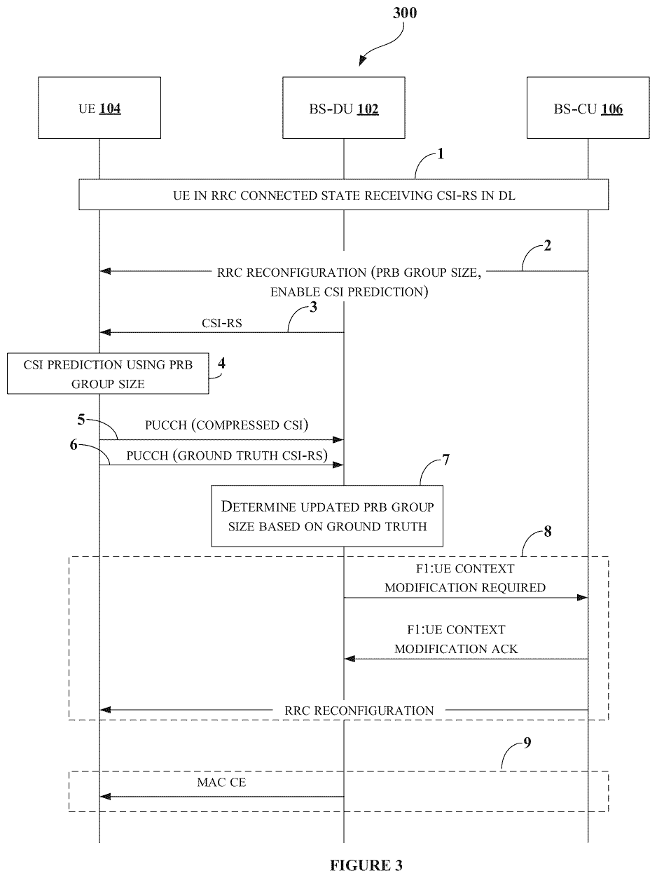

In an embodiment, the communication module 220 transmits the PRB group size in a Radio Resource Control (RRC) reconfiguration message over the Downlink (DL). In an example, the communication module 220 transmits the RRC reconfiguration message with the PRB group size as four. In such case, the UE 104 performs the CSI prediction for 4 PRBs. Referring to a flow diagram 300 illustrated in FIG. 3, the UE 104 is in RRC connected state, as shown in step 1. The communication module 220 transmits the RRC reconfiguration message including the PRB group size to the UE 104, as shown in step 2. The communication module 220 transmits the CSI-RS to the UE 104, as shown in step 3. The UE 104 performs the CSI prediction using the PRB group size, as shown in step 4.

Referring back to FIG. 2, in an embodiment, the communication module 220 may be configured to receive compressed CSI feedback from the UE 104, in response to transmission of the CSI-RS. The CSI feedback is generated by the UE 104 based on the CSI-RS received from the BS-DU 102. Further, the CSI feedback is compressed by the UE 104 based on the one or more channel parameters of the wireless channel. The one or more channel parameters may include channel selectivity, angular speed, and the like. The compressed CSI feedback may include only specific portions of data which helps in analysis of the wireless channel. For example, consider the wireless channel is a frequency flat channel. For the frequency flat channel, useful data may be present only in specific portions of the CSI feedback. In such case, frequency granularity of reporting can be reduced over time for frequency flat channels. In another example, spatial granularity of reporting can be changed based on angular spread in the wireless channel. This ensures reduced uplink overhead in the wireless communication network, without losing the channel information. Also, CSI feedback channel includes stringent error requirements, and hence reducing the overhead significantly reduces uplink resources for transmission. Referring again to FIG. 3, the communication module 220 receives the compressed CSI feedback from the UE 104 over a Physical Uplink Control Channel (PUCCH), at step 5. Referring back to FIG. 2, the CSI-RS, the compressed CSI feedback, and the PRB group size may be stored as the communication data 212 in the memory 204.

In an embodiment, the communication module 220 may be configured to receive a ground truth CSI-RS periodically from the UE 104. The communication module 220 may receive the ground truth CSI-RS periodically from the UE 104 after transmitting the CSI-RS and a PRB group size initially. In an embodiment, the communication module 220 may be configured to receive the ground truth CSI-RS from the UE 104 at pre-defined time intervals. The ground truth CSI-RS comprises actual CSI-RS samples as received by the UE 104 from the BS-DU 102. The communication module 220 receives the ground truth CSI-RS, so that the channel selectivity parameters of the wireless channel can be monitored. The monitoring of the wireless channel helps to determine whether the PRB group size needs to be updated, based on chancel selectivity parameters of the wireless channel. The present disclosure provides a procedure to receive the ground truth CSI-RS from the UE 104 to dynamically update or optimize the PRB group size, based on the channel selectivity parameters. This ensures increased accuracy in performing the CSI prediction and reporting at the UE 104. Referring again to FIG. 3, the communication module 220 receives the ground truth CSI-RS over the PUCCH from the UE 104, as shown in step 6. Referring back to FIG. 2, the ground truth CSI-RS may be stored as the communication data 212 in the memory 204.

In an embodiment, the channel value determination module 222 is configured to receive the communication data 212 from the communication module 220. Further, the channel value determination module 222 is configured to determine values of one or more channel selectivity parameters of the wireless channel, based on the received ground truth CSI-RS from the UE 104. The one or more channel selectivity parameters may comprise at least one of, a frequency selectivity, a spatial selectivity, and a time selectivity of the wireless channel. The channel value determination module 222 may be configured to determine variations of amplitude over at least one of, a frequency domain, a spatial domain, and a time domain. In an example, the channel value determination module 222 may determine a high frequency selectivity for a frequency flat channel. The values of the one or more channel selectivity parameters may be stored as the channel data 214 in the memory 204.

In an embodiment, the PRB size determination module 224 may be configured to receive the channel data 214 from the channel value determination module 222. Further, the PRB size determination module 224 may be configured to determine an updated PRB group size, based on changes in the values of the one or more channel selectivity parameters. The PRB group size is affected by the one or more channel selectivity parameters of the wireless channel. As properties of the wireless channel may change frequently over time, it is necessary to update the PRB group size used for the CSI prediction. The PRB size determination module 224 may determine whether the PRB group size needs to be updated based on the one or more channel selectivity parameters. The PRB size determination module 224 may determine the updated PRB group size, based on the one or more channel selectivity parameters. In an example, for a frequency flat channel, the frequency selectivity may be high. Consider an initial PRB size transmitted to the UE 104 as four. In such case, the PRB size determination module 224 may determine the updated PRB group size ‘2’, as the PRB group size is inversely proportional to the frequency selectivity of the wireless channel. Referring again to FIG. 3, the channel value determination module 222 may determine the updated PRB group size, based on changes in the values of the one or more selectivity parameters determined from the ground truth CSI-RS, at step 7. Referring back to FIG. 2, the updated PRB group size may be stored as the PRB size data 216 in the memory 204.

In an embodiment, the communication module 220 may be configured to receive the PRB size data 216 from the PRB size determination module 224. Further, the communication module 220 may be configured to transmit the updated PRB group size to the UE 104. In an embodiment, the communication module 220 may transmit the request indicating the updated PRB group size to the BS-CU 106. Further, the communication module 220 may receive an acknowledgement from the BS-CU 106. In such case, the BS-CU 106 transmits a RRC reconfiguration message indicating the updated PRB group size to the UE 104. In another embodiment, the communication module 220 transmits the updated PRB group size in a medium access control message, to the UE 104. This ensures reduced signaling in the wireless network. In the present disclosure, the PRB group size is updated dynamically based on the channel characteristics. This ensures accuracy of CSI prediction performed at the UE 104.

The other data 218 may store data, including temporary data and temporary files, generated by the one or more modules 210 for performing the various functions of the BS-DU 102. The other data 218 may be stored in the memory 204. The one or more modules 210 may also include the other modules 226 to perform various miscellaneous functionalities of the BS-DU 102.

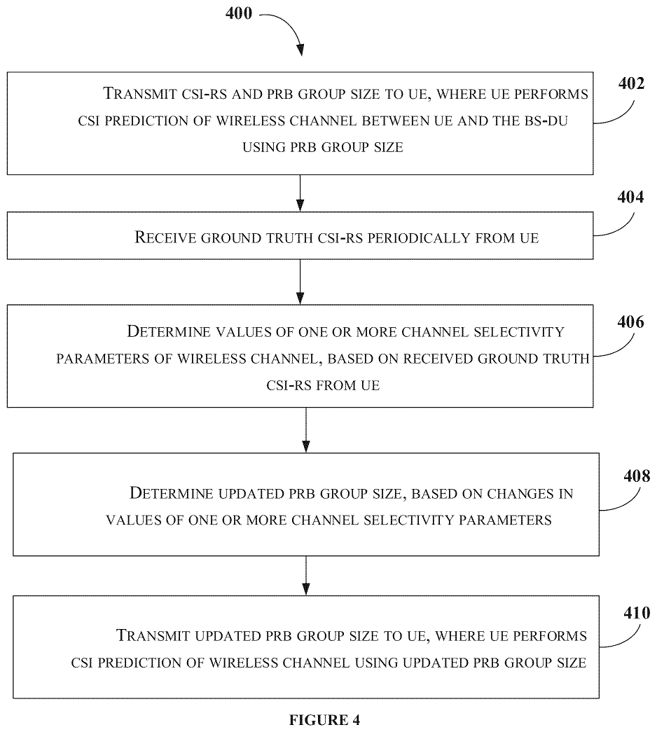

FIG. 4 shows an exemplary flow chart illustrating method steps for reporting the CSI feedback in the wireless networks, in accordance with some embodiments of the present disclosure. As illustrated in FIG. 4, the method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 401, the CSI-RS and the PRB group size are transmitted to the UE 104. The CSI-RS and the PRB group size is transmitted when the BS-DU 102 establishes a connection with the UE 104 over a wireless channel or a radio channel. The PRB group size is transmitted in a Radio Resource Control (RRC) reconfiguration message over the downlink (DL).

At step 402, the ground truth CSI-RS may be received periodically from the UE 104. The ground truth CSI-RS may be received periodically from the UE 104 after transmitting the CSI-RS and a PRB group size initially. In an embodiment, the ground truth CSI-RS may be received from the UE 104 at pre-defined time intervals. The ground truth CSI-RS comprises actual CSI-RS samples as received by the UE 104 from the BS-DU 102.

At step 403, the values of one or more channel selectivity parameters of the wireless channel are determined, based on the received ground truth CSI-RS from the UE 104. The one or more channel selectivity parameters may comprise at least one of, a frequency selectivity, a spatial selectivity, and a time selectivity of the wireless channel. The variations of amplitude over at least one of, a frequency domain, a spatial domain, and a time domain are determined.

At step 404, the updated PRB group size is determined, based on changes in the values of the one or more channel selectivity parameters. The PRB group size is affected by the one or more channel selectivity parameters of the wireless channel. As properties of the wireless channel may change frequently over time, it is necessary to update the PRB group size used for the CSI prediction. The updated PRB group size may be determined based on the one or more channel selectivity parameters.

At step 405, the updated PRB group size is transmitted to the UE 104. In an embodiment, the request indicating the updated PRB group size is transmitted to the BS-CU 106. Further, an acknowledgement is received from the BS-CU 106. In such case, the BS-CU 106 transmits a RRC reconfiguration message indicating the updated PRB group size to the UE 104. In another embodiment, the updated PRB group size is transmitted in a medium access control message, to the UE 104.

### Computer System

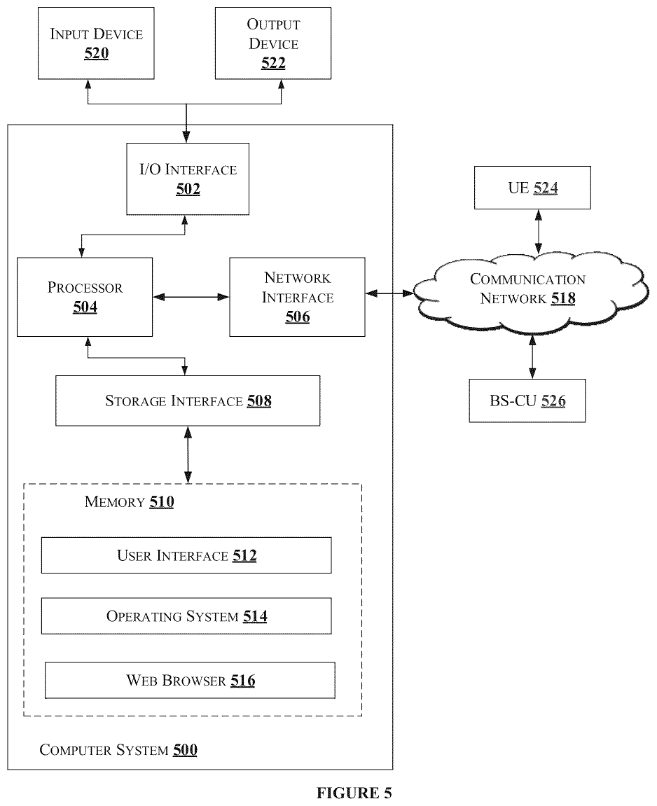

FIG. 5 illustrates a block diagram of an exemplary computer system 500 for implementing embodiments consistent with the present disclosure. In an embodiment, the computer system 500 may be used to implement the BS-DU 102. In an embodiment, the computer system 500 may communicate with the UE 524 and the BS-CU 526, over a communication network 518. The computer system 500 may comprise a Central Processing Unit 504 (also referred as “CPU” or “processor”). The processor 504 may comprise at least one data processor. The processor 504 may include specialized processing units such as integrated system (bus) controllers, memory management control units, floating point units, graphics processing units, digital signal processing units, etc.

The processor 504 may be disposed in communication with one or more input/output (I/O) devices (not shown) via I/O interface 502. The I/O interface 502 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 502, the computer system 500 may communicate with one or more I/O devices. For example, the input device 520 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, sensors, etc. The output device 522 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 504 may be disposed in communication with the communication network 518 via a network interface 506. The network interface 506 may communicate with the communication network 518. The network interface 506 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 518 may include, without limitation, a direct interconnection, local area network (LAN), wide area network (WAN), wireless network (e.g., using Wireless Application Protocol), the Internet, etc. The network interface 506 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, Bluetooth mesh, Zigbee, etc.

The communication network 518 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 504 may be disposed in communication with a memory 510 (e.g., RAM, ROM, etc. not shown in FIG. 5) via a storage interface 508. The storage interface 508 may connect to memory 510 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 510 may store a collection of program or database components, including, without limitation, user interface 512, an operating system 514, web browser 516 etc. In some embodiments, computer system 500 may store user/application data, such as, the data, variables, records, etc., as described in this disclosure. Such databases may be implemented as fault-tolerant, relational, scalable, secure databases such as Oracle® or Sybase®.

The operating system 514 may facilitate resource management and operation of the computer system 500. Examples of operating systems include, without limitation, APPLE MACINTOSH^{R} OS X, UNIX^{R}, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE^{R} IOS™, GOOGLE^{R} ANDROID™, BLACKBERRY^{R} OS, or the like.

In some embodiments, the computer system 500 may implement the web browser 516 stored program component. The web browser 516 may be a hypertext viewing application, for example MICROSOFT^{R} INTERNET EXPLORER™, GOOGLE^{R} CHROME™0, MOZILLA^{R} FIREFOX™, APPLE^{R} SAFARI™, etc. Secure web browsing may be provided using Secure Hypertext Transport Protocol (HTTPS), Secure Sockets Layer (SSL), Transport Layer Security (TLS), etc. Web browsers 516 may utilize facilities such as AJAX™, DHTML™, ADOBE^{R} FLASH™, JAVASCRIPT™, JAVA™, Application Programming Interfaces (APIs), etc. In some embodiments, the computer system 500 may implement a mail server (not shown in Figure) stored program component. The mail server may be an Internet mail server such as Microsoft Exchange, or the like. The mail server may utilize facilities such as ASP™, ACTIVEX™, ANSI™ C++/C #, MICROSOFT^{R}, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT^{R} exchange, Post Office Protocol (POP), Simple Mail Transfer Protocol (SMTP), or the like. In some embodiments, the computer system 500 may implement a mail client stored program component. The mail client (not shown in Figure) may be a mail viewing application, such as APPLE^{R} MAIL™, MICROSOFT^{R} ENTOURAGE™, MICROSOFT^{R} OUTLOOK™, MOZILLA^{R} THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 shows certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A Base Station (BS)-Distributed Unit (DU) (102), configured to:
transmit a Channel State Information Reference Signal (CSI-RS) and a Physical Resource Block (PRB) group size to a User Equipment (UE) (104), wherein the UE (104) performs CSI prediction of a wireless channel between the UE (104) and the BS-DU (102) using at least the PRB group size;
determine changes in the values of one or more channel selectivity parameters of the wireless channel;
determine an updated PRB group size, based on changes in the values of the one or more channel selectivity parameters; and
transmit the updated PRB group size to the UE (104), wherein the UE (104) performs the CSI prediction of the wireless channel using at least the updated PRB group size.

2. The BS-DU (102) of claim 1, configured to:
receive compressed CSI feedback from the UE (104), in response to transmission of the CSI-RS, wherein the compressed CSI feedback is generated by the UE (104) based on one or more channel parameters of the wireless channel.

3. The BS-DU (102) of claim 1, wherein the one or more channel selectivity parameters comprise at least one of, a frequency selectivity, a spatial selectivity, and a time selectivity of the wireless channel.

4. The BS-DU (102) of claim 1 is configured to transmit the updated PRB group size to the UE (104) by:
transmitting a request indicating the updated PRB group size to a Base Station-Central Unit (BS-CU) (106); and
receiving an acknowledgement from the BS-CU (106) in response to the request, wherein the BS-CU (106) transmits a Radio Resource Control (RRC) reconfiguration message indicating the updated PRB group size to the UE (104).

5. The BS-DU (102) of claim 1 is configured to transmit the updated PRB group size in a medium access control message, to the UE (104).

6. A method, comprising:
transmitting, by a Base Station (BS)-Distributed Unit (DU) (102), a Channel State Information Reference Signal (CSI-RS) and a Physical Resource Block (PRB) group size to a User Equipment (UE) (104), wherein the UE (104) performs CSI prediction of a wireless channel between the UE (104) and the BS-DU (102) using at least the PRB group size;
determining, by the BS-DU (102), values of one or more channel selectivity parameters of the wireless channel;
determining, by the BS-DU (102), an updated PRB group size, based on changes in the values of the one or more channel selectivity parameters; and
transmitting, by the BS-DU (102), the updated PRB group size to the UE (104), wherein the UE (104) performs the CSI prediction of the wireless channel using at least the updated PRB group size.

7. The method of claim 6, comprising:
receiving compressed CSI feedback from the UE (104), in response to transmission of the CSI-RS, wherein the compressed CSI feedback is generated by the UE (104) based on one or more channel parameters of the wireless channel.

8. The method of claim 6, wherein the one or more channel selectivity parameters comprise at least one of, a frequency selectivity, a spatial selectivity, and a time selectivity of the wireless channel.

9. The method of claim 6, wherein transmitting the updated PRB group size to the UE (104) comprising:
transmitting a request indicating the updated PRB group size to a Base Station-Central Unit (BS-CU) (106); and
receiving an acknowledgement from the BS-CU (106) in response to the request, wherein the BS-CU (106) transmits a Radio Resource Control (RRC) reconfiguration message indicating the updated PRB group size to the UE (104).

10. The method of claim 6, wherein the updated PRB group size is transmitted in a medium access control message, to the UE (104).

11. A non-transitory computer readable medium including instructions for performing operations comprising:
transmitting a Channel State Information Reference Signal (CSI-RS) and a Physical Resource Block (PRB) group size to a User Equipment (UE) (104), wherein the UE (104) performs CSI prediction of a wireless channel between the UE (104) and a Base Station (BS)-Distributed Unit (DU) (102) using at least the PRB group size;
determining values of one or more channel selectivity parameters of the wireless channel;
determining an updated PRB group size, based on changes in the values of the one or more channel selectivity parameters; and
transmitting the updated PRB group size to the UE (104), wherein the UE (104) performs the CSI prediction of the wireless channel using at least the updated PRB group size.

12. The medium of claim 11, wherein the operations comprising:
receiving compressed CSI feedback from the UE (104), in response to transmission of the CSI-RS, wherein the compressed CSI feedback is generated by the UE (104) based on one or more channel parameters of the wireless channel.

13. The medium of claim 11, wherein the one or more channel selectivity parameters comprise at least one of, a frequency selectivity, a spatial selectivity, and a time selectivity of the wireless channel.

14. The medium of claim 11, wherein transmitting the updated PRB group size to the UE (104) comprising:
transmitting a request indicating the updated PRB group size to a Base Station-Central Unit (BS-CU) (106); and
receiving an acknowledgement from the BS-CU (106) in response to the request, wherein the BS-CU (106) transmits a Radio Resource Control (RRC) reconfiguration message indicating the updated PRB group size to the UE (104).

15. The medium of claim 11, wherein the updated PRB group size is transmitted in a medium access control message, to the UE (104).
